(19) United States
(12) Patent Application Publication
(10) Pub. No.: US 2013/0082223 A1
(43) Pub. Date: Apr. 4, 2013

(54) TENSION CONTROL DEVICE FOR AN ANCHOR LINE ROPE

(71) Applicants: Anders Kippernes, Averoy (NO); Harald Kåre Staurnes, Averoy (NO)

(72) Inventors: Anders Kippernes, Averoy (NO); Harald Kåre Staurnes, Averoy (NO)

(73) Assignee: TRIPLEX AS, Averoy (NO)

(21) Appl. No.: 13/696,325

(22) PCT Filed: May 6, 2011
(86) PCT No.: PCT/NO2011/000148

§ 371 Date: Nov. 26, 2012

(30) Foreign Application Priority Data
May 7, 2010 (NO) 20100662

(51) Int. Cl. B66D 1/50

(52) U.S. Cl. CPC B66D 1/50
USPC 254/277

(57) ABSTRACT

A tension control device for an anchor line rope of large diameter, which winds off or onto a winch drum at a marine vessel includes an arm with a first inner link arm with a first sheave arranged near the first link arm's outer end, a second, intermediate link arm arranged rotatable adjustable on the first arm and arranged with a second intermediate sheave near the second link arm's outer end, and a third, outer link arm arranged rotatable adjustable on the second, intermediate link arm and arranged with a third sheave near the third, outer link arm's outer end. The second, intermediate link arm's angle is regulated by use of a first actuator arranged between the first, inner link arm and the second link arm. The third, outer link arm's relative angle to the second, intermediate link arm is regulated by a second actuator. Each sheave includes a brake.

The present invention relates to handling of fiber ropes for offshore mooring anchor spreads. More specifically the present invention is meant for tensioning very thick ropes in connection with spooling ropes off or on a storage drum or re-spooling between a storage drum and a winch drum, typically on board of an offshore vessel, more specifically an anchor handling vessel.

### BACKGROUND

Wire and chain has traditionally been used for anchoring vessels or platforms. A single anchor line in an anchor spread may traditionally comprise an anchor at several kilometers distance from the position of the platform, a very gross anchor chain that runs along the seabed towards the position of the platform to a touch-down point where the chains leaves the seabed, and with a wire, generally of 75-90 mm diameter, extending further along a natural catenary line up towards the position of the platform, and with an anchor winch chain along the last portion into an anchor winch at the platform. Depending of the depth, the wire range may be between 900 and 1800 meter long, or longer. In an operative moored position the wire then will extend, through the sea, over a distance exposed to little wear, and the anchor winch chain in the upper part and the anchor chain in the lower part handles the sections exposed to wear.

Recently, fiber rope has taken over more and more of the functions of the wire, particularly during lay-out of anchors at great depth. The fiber rope may be of thickness from about 125 mm to 250 mm diameter and has the big advantage that it is a) elastic and b) lighter than a steel wire, and c) nearly weight neutral in the sea water.

The fiber rope must regardless be handled out and in of a anchor handling vessel which normally prepares a “anchor spread” of eight to twelve anchor lines spread out in a star shaped formation, with buoys with fiber rope laid out and around the platform's anchoring position in due time prior to the arrival of the platform so that the lines may be connected to the platform and tightened up as a final part of the operation. To lay out an anchor with an anchor line may take more than 24 hours per anchor, and there are more alternatives for lay-outs, but they are roughly similar to the lay-out described above.

Due to the large diameter of the fiber rope and the consequently limited capacity of the storage drum and the winch drum, it is divided into sections, generally in multiples by lengths of 300 m: 300 m, 600 m, 90 m, or 1200 m, and those are connected to the existing part of the polyester rope line while fed out, or vice versa when it is hauled in.

### PRIOR ART

U.S. Pat. No. 4,846,446 A relates to an apparatus to attenuate the tension variations in an anchor line. The apparatus comprises two coplanar sheaves on the opposite ends of a rotatable arm. The anchor line rope is in this apparatus supported in an s-shape and during increased tension of the rope the sheaves move in a way that the path is more or less straightened.

DE-102005028334 A1 relates to an apparatus to control the tension in a long paper web, wherein the apparatus comprises a plurality of cylinders. Actuators may move the cylinders either one at a time or in combinations in a way that the length of the paper web through the cylinder system is adjusted and the paper tension is varied.

U.S. Pat. No. 7,389,973 B1 relates to an apparatus to increase the tension in a cable or line for use in subsea operations. The system comprises two rows of sheaves, placed on either sides of a large frame and is movable relative to a symmetry line. By adjusting the positions of the two rows of sheaves internally the running distance for the cable or line through the apparatus is increased. Such an apparatus requires a large amount of sheaves and actuators and will be very space demanding on deck.

U.S. Pat. No. 4,171,640 A1 relates to a measuring apparatus for measuring the tension in a line, the line being thread into a system of three sheaves, one of the sheaves is rotatably fixed to the frame and provided with a pressure sensor, and when the line is tensioned this will show on the sensor.

During feeding out or hauling in anchor lines or heavy equipment in the sea, heavy load will occur and with that large tensile stress in a fiber rope. When rewinding, hauling in or feeding out fiber rope, a number of problems, by a probably common cause, may occur. Fiber rope lying exterior to an underlying layer of fiber rope penetrates down into the underlying layer between its windings. This is particularly relevant when it comes to when e.g. laying out an anchor, applies large force to the fiber rope, and this penetrates down into underlying winding layer. This is a very undesirable situation which often occur if the spool is wound loose, too spread or under insufficient tension. This may result in damage of the fiber rope such as partly melting, fibrillating and partial or total breakage. Further complications may occur if the fiber rope is inflicted by damage or fiber breakage by sharp bending or high temperature caused by friction arising between layers at the reel which slip internally.

### SHORT SUMMARY OF THE INVENTION

A solution to the above mentioned problems is a tension control device (20) for an anchor line rope (10) of large diameter, which winds off or on a winch drum (4) at a marine vessel (6), wherein the characteristic of the invention is an arm (21) comprising
a first, inner link arm (22) with a first sheave (23) arranged near the first link arm's (22) outer end,
a second, intermediate link arm (24) arranged rotatable adjustable on the first inner link arm (22) and arranged with a second, intermediate sheave (25) near the second link arm's (24) outer end, and
a third, outer link arm (26) arranged rotatable adjustable on the second intermediate link arm (24) and arranged with a third sheave (27) near the third, outer link arm's (26) outer end,
wherein the second intermediate link arm's (24) angle is controlled by use of a first actuator (24a) between the first, inner link arm (22) and the second link arm (24),
wherein the third, outer link arm's (26) relative angle to the second, intermediate link arm (24) is controlled by a second actuator (26a) between the second, intermediate link arm (24) and the third, outer link arm (26),
wherein each sheave (23, 25, 27) comprises a brake (23m, 25m, 27m).

### ADVANTAGES OF THE INVENTION

By the use of the present invention the winch drum will be wound by fiber rope with adjustable and sufficiently high tension and the possibility for controlled winding. The above mentioned complications may to a significant degree be eliminated.

Spooling and tensioning by use of the invention takes place bay passing over a three-reels system, and the reel system may be decelerated so that a tension force up to 50 tons at the tension side may arise.

By sufficient tensioning of the fiber rope running in to the drum one may prevent that the subsequent fibre rope layer penetrates into the reel, i.e. into the underlying layer.

The device according to the invention is less space demanding compared to U.S. Pat. No. 7,389,973 B1 since it only comprise three reels and that it takes advantage of the possibility for regulation due to the ropes arc lengths about the reels for adjusting the friction forces.

A further advantage is that the hydraulic motors, connected to the present, invention's sheaves, arranged for driving or breaking the fiber rope in either directions through the apparatus.

Another advantage by the present invention is that the fiber rope's horizontal position at the drum may run free or be regulated by the use of the rotatable inner link arm around the axis of which it is suspended.

### SHORT FIGURE CAPTIONS

FIG. 1 illustrates an anchor line lay-out to one side of a floating platform (1) with an anchor (8), an anchor chain (9), an anchor line (10), an anchor winch chain (11), an anchor winch (12). a winch drum (5) and a storage drum (4) for anchor line-rope (10) and is used to lay out or haul in the anchor line.

FIG. 2a is a side elevation view of an embodiment of a tension control device according to the invention.

FIG. 2b is a side elevation view of the same tension control device wherein an anchor line of large diameter is illustrated running through the tension control device. The tension control device is shown in a partly contracted condition so that the arc lengths for the anchor line become long. Hydraulic lines for hydraulic cylinders and the motors are left out of the drawing.

FIG. 3a is a front elevation view of the same tension control device and shows a suspension to a structural part of a vessel. The tension control device is shown in vertical position.

FIG. 3b is a front elevation view as in FIG. 3a, but wherein the tension control device is rotated out to a horizontal position.

FIG. 4 is a perspective view of the invention according to the invention in a similar position as in FIG. 3a.

FIG. 5 is a top elevation view of the tension control device according to the invention, in a similar position as in FIG. 3a.

FIG. 6a is a perspective view aslant from the front of the tension control device arranged in a travelling crane over the working deck at a anchor handling vessel (6), and shows anchor line rope winding from a storage drum arranged on land, wherein the anchor line has been laid around the inner and the intermediate of the reels at the arm. The triple reel arm at the tension control device tensions the rope so it does not sweep the deck.

FIG. 6b is a perspective sketch similar to FIG. 6 wherein the third reel is elevated and in that way lifting and tensioning the anchor line even more.

FIG. 6c shows a perspective elevation from abaft the beam for the same situation as in FIG. 6b, but wherein only the travelling crane with the tension control device according to the invention is shown.

FIG. 7a is a situation sketch of the tension control device arranged in a travelling crane over a work deck at a anchor handling vessel (6), and shows rewinding from a storage drum, placed on the same working deck, to a winch drum at higher elevated deck. Suitable tension of the rope onto the winch drum is set by the triple reel with controlled braking.

FIG. 7b is a perspective view similar to the perspective view of FIG. 6c, and shows the travelling crane, the tension control device and a part of the rope running between for instance the storage drum and the winch drum. The tension control device in this sketch is somewhat more contracted than what is shown in FIG. 7a.

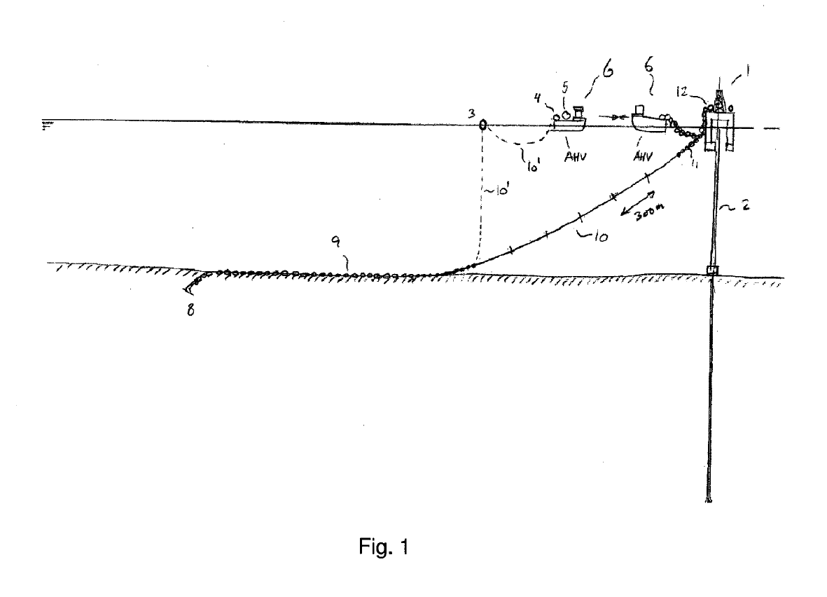

### EMBODIMENTS OF THE INVENTION

The present invention relates to handling of fiber ropes in offshore mooring anchor spreads. A preferred embodiment of the invention is a tension control device (20) for an anchor line rope (10) of large diameter, which winds off or onto a winch drum (4) at a marine vessel (6), wherein the tension control device comprises the following features: an arm (21) with a first, inner link arm (22) with a first sheave(23) arranged near the first link arms (22) outer end, a second, intermediate link arm (24) arranged rotatable adjustable on the first inner link arm (22) and arranged with a second intermediate sheave (25) near the second link arm's (24) outer end, and a third, outer link arm (26) arranged rotatable adjustable on the second, intermediate link, arm (24) and arranged with a third sheave (27) near the third, outer link arm's (26) outer end. The second, intermediate link arm's (24) angle is regulated by use of a first actuator (24a) arranged between the first, inner link arm (22) and the second link arm (24) so that the arc length (b23) of the anchor line rope (10) around the first, inner sheave (23) and the second, intermediate sheave (25) is regulated and wherein the third, outer link arm's (26) relative angle to the second, intermediate link arm (24) is regulated by a second actuator (26a) between the second, intermediate link arm (24) and the third, outer link arm (26), in this way regulating the anchor line rope's (10) arc length (b25) around the second intermediate sheave (25) and accordingly regulating the anchor line rope's (10) arc length (b27) around the third, outer sheave (27), and each sheave (23, 25, 27) comprises a brake (23m, 25m, 27m) which together are arranged for tension regulating the anchor line rope (10).

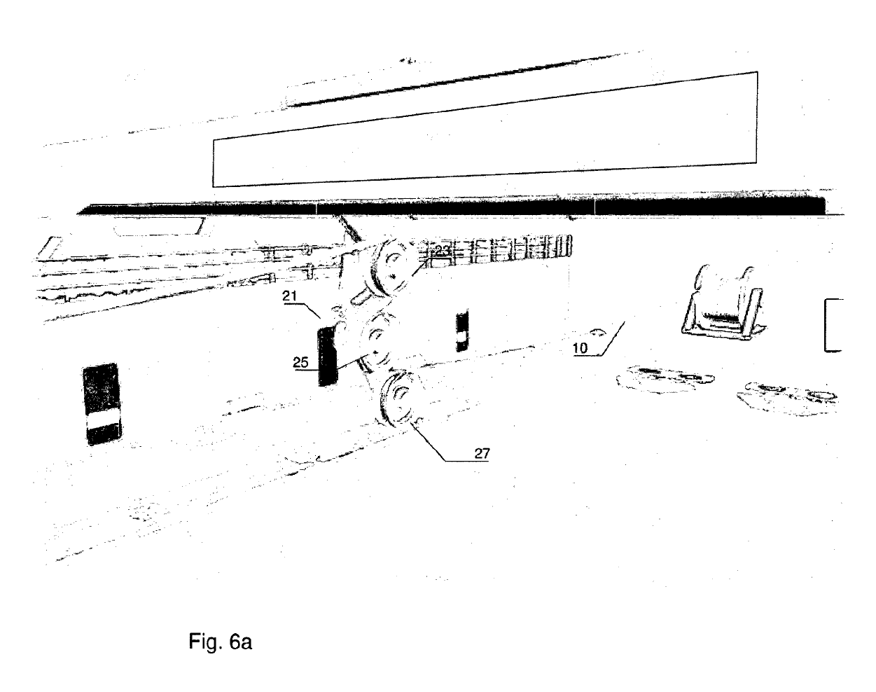

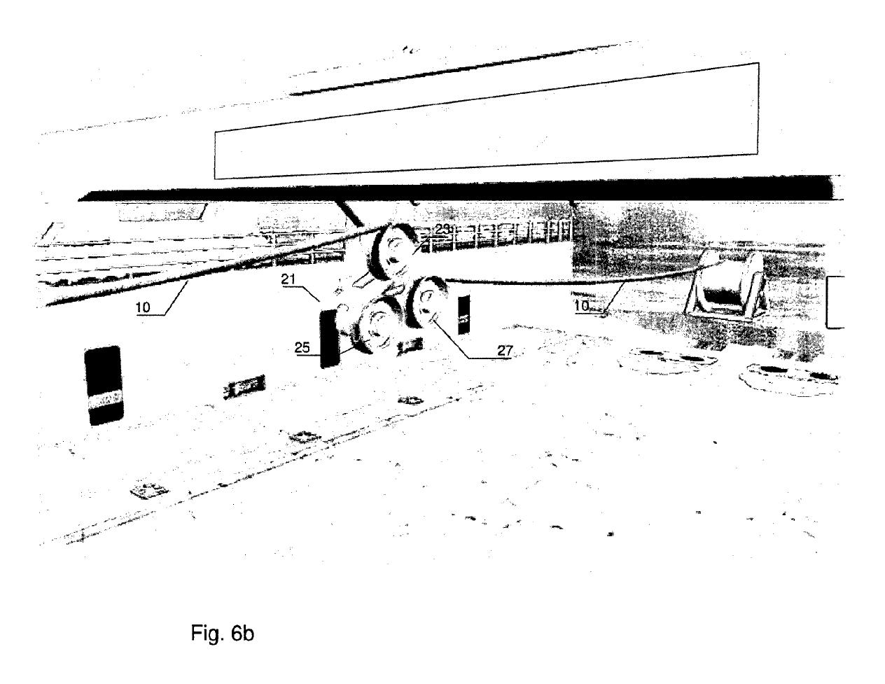

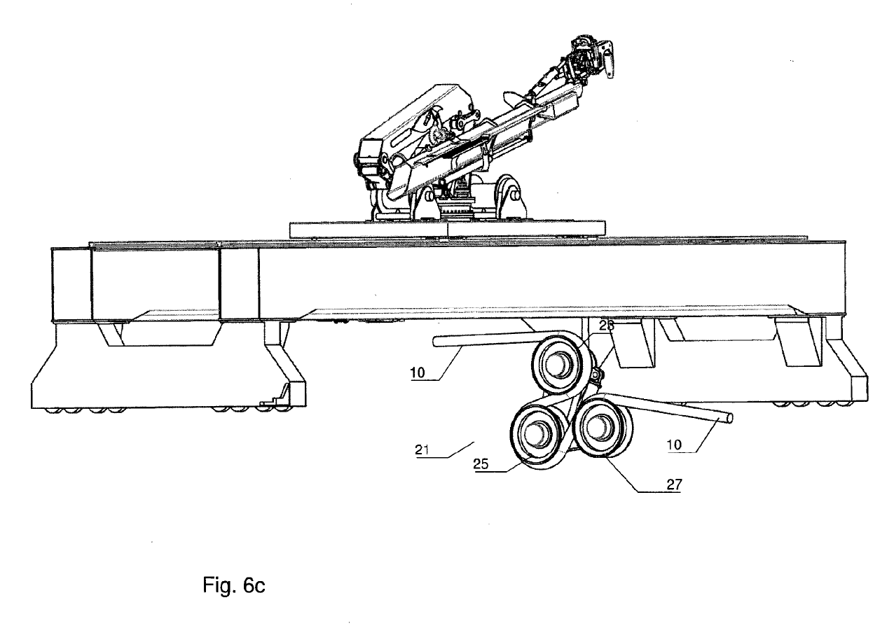

In an embodiment of the tension control device (20) according to the present invention, the first inner link arm (22) is rotatable suspended about a shaft (31) generally perpendicular to the shaft of at least the first inner sheave (23) and, comprises a actuator (29a), cross mounted, arranged for regulating the link arms (22) and accordingly the arm's (21) angle (v29) about the shaft (31). A bearing (33) supports the shaft (31) on a structural base at the vessel. The first, inner link arm (22) may be arranged on the structural base as for instance may be a travelling crane as shown in FIG. 6.

In an embodiment of the tension control device (20) according to the present invention, the first, second, and the third sheave (23, 25, 27) provided with key slots (43, 44, 45) accordingly.

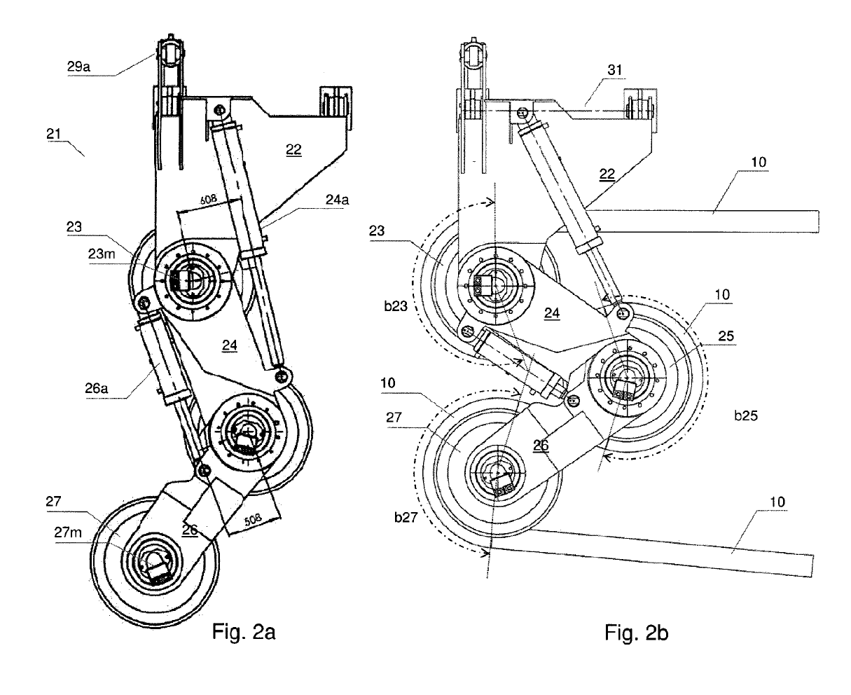

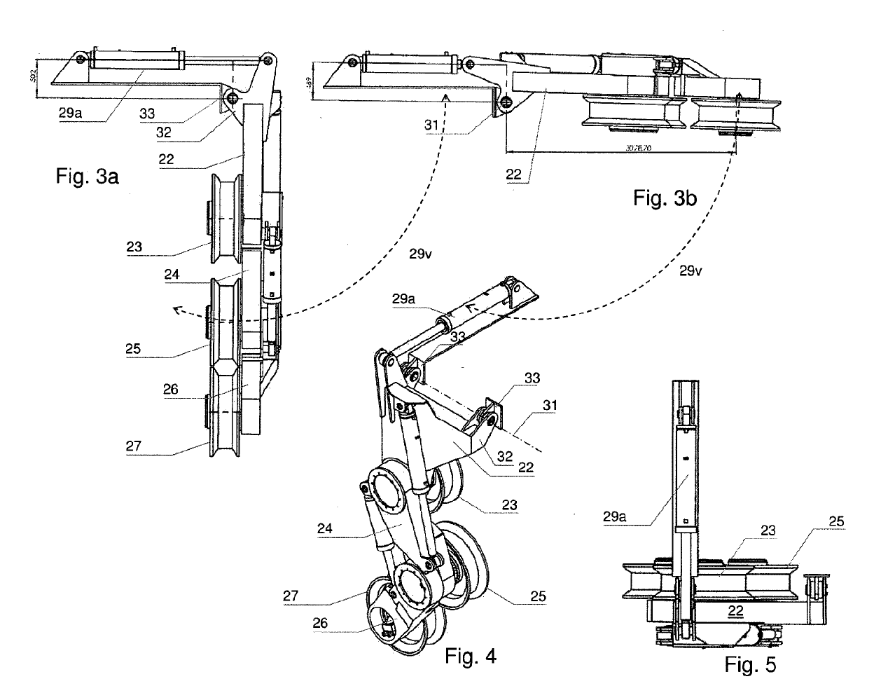

In an embodiment of the tension control, device (20) according to the present invention, the first, second and the third sheave (23, 25, 27) are arranged coplanar as shown in FIGS. 3a, 3b and 5. The sheaves may preferably be of the same size, with a diameter in the order of 1 meter. In an embodiment of the tension control device (20) according to the present invention, the brakes (23m, 25m, 27m) comprise torque regulating motors, preferably hydraulic motors as shown in FIGS. 2a and 2b. In other words the invention comprises a tiltable, flexible arm with three keyed wheels or sheaves, wherein the multiply flexible arm comprises two link arm sections each comprising sheaves, wherein the flexible joints are rotatable around the sheave axis. The three sheaves are preferably coplanar. The tilt movement is actuated by the hydraulic cylinder (29a). The intermediate- and the outer link arms (24, 26) of the arm (21) may mutually independently be adjusted or moved by means of the two hydraulic actuators (24a, 26a), one for each link arm. The lengths of the link arms of the arm (21) is set according to the need for distances and maximal tension in the anchor line rope (10). In preferred embodiment of the invention the tread surface of the sheaves (23, 25, 27) is covered by vulcanized rubber. In another preferred embodiment the sheaves (23, 25, 27) are arranged with slots with flat bottom, as V-belt sheaves. Three independent hydraulic motors (23m, 25m, 27m) run or brake the sheaves (23,25, 27). The sheaves may have similar design independent of the diameter or the quality of the fiber rope, but in a preferred embodiment they are designed with diameter and with arranged for handling the largest known fiber lime in the market, as per today is about 250 mm.

One may assume that the spool or winch drum onto which the line is wound, runs with constant speed. Under this condition it is most probably that the placing of the line is performed controlled and with even tension. The speed or the torque at the sheave motors (23m, 25m, 27m) may be regulated to a desired direction or force as for the fiber rope between the outlet wheel (may optional be the inner or the outer sheave), and the drum at the winch may be tightened until a desired winding tension is achieved (or if necessary loosened). The motors (23m, 25m, 27m) may be hydraulic connected to work simultaneous, or be driven or regulated individually. When hauling in an anchor line from the sea where the load is e.g. 70 tons, an one wishes to wind it with a force corresponding to 50 tons at the winch drum, this may be regulated by using driving motors (23m, 25m, 27m). By changing position of the link arms and the sheaves, the contact length and the arc length changes, and with that the friction between the thread and the fiber rope. When both cylinders are entirely at the “in” position,. total friction forming contact length (the total arc length), and depending on the braking force, the potential tensile forces are at its highest. When the cylinders are driven outwards the arc lengths are reduced and with that the contact lengths and the friction forces. The possible gained friction force at the line running out is a function of the force into the line and an exponential function of the arc length. This is valid for every single wheel whether it is decelerated or driven.

A significant benefit by the invention is that splices, such as shackles, chain parts or the like, at the fiber rope, may freely pass over the wheels by straightening the arm by at least two link arms, wherein the curves straighten, mainly straight out, and the distance or space between the first and the third of the wheels increases so as for a stiff piece may pass. Thus there is no need for other operations to get a continuous winding with unaltered tensile forces than to run the cylinders out or in, respectively.

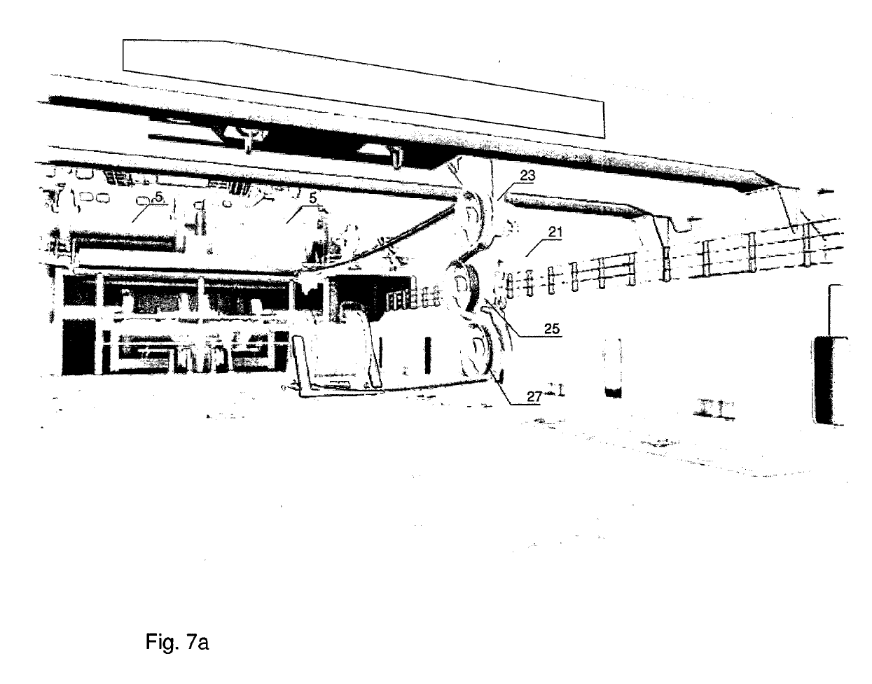

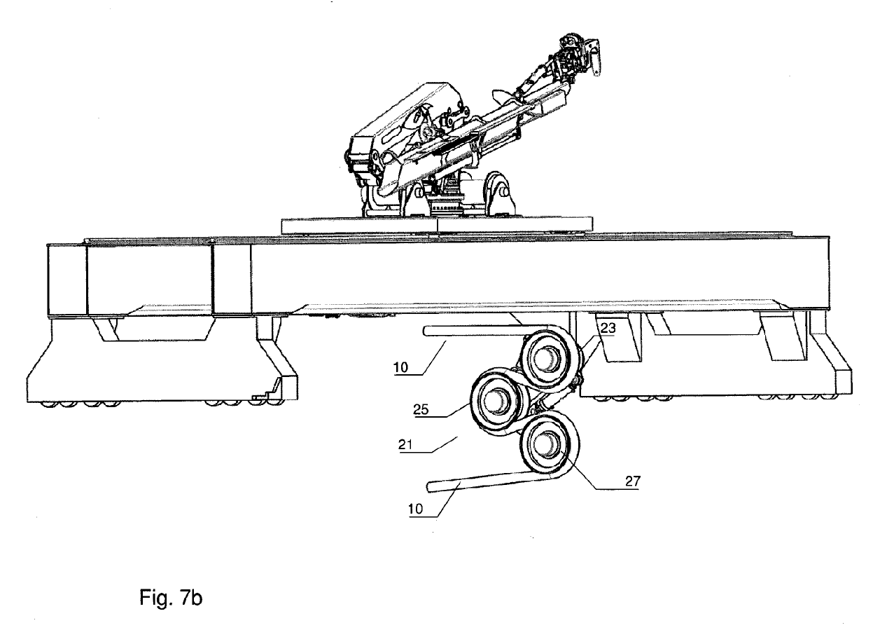

An other substantial advantage by the invention is that in situations as illustrated in FIGS. 6a, 6b and 7a, all concerning rewinding of line over deck, one may prevent that the, rope sweeps the deck. This reduces the risk of damages to the rope (and also to equipment on deck) and wear of the rope.

The easiest way of threading the line may be when the link arms of the arm are fully extended. It is further important that the diameter of the wheels correspond to the characteristics and specifications of the fiber rope so as the line is not bent around a too small radius, or that the wheels' keyways are not unnecessary wide relative to the line in use.

In a preferred embodiment of the invention, as for instance shown in FIG. 6a, the wheels (23,25,27) are arranged at one side of the arm (21) when the hydraulic equipment such as cylinders, motors and hoses is arranged on the opposite side of the arm (21). This brings two advantages: on the one hand the threading of the anchor line (10) in the apparatus becomes easier, and on the other hand it will prevent contact between the anchor line and especially the hydraulic cylinders and hoses as reduces risks of damage on the hydraulic components.

The apparatus according to invention may either be mounted disconnectable at a ship deck or in other structures at a ship (e.g. in the cargo rail), or at a crane, typically a travelling crane which may move the spooling apparatus both alongside and abeam, or in just one of the directions.

The direction of mounting may either be horizontal or vertical, hanging or standing.

1. A tension control device for an anchor line rope of large diameter, which winds off or on a winch drum at a marine vessel, comprising:
a first, inner link arm with a first sheave arranged near the first link arm's outer end,
a second, intermediate link arm arranged rotatable adjustable on the first inner link arm and provided with a second, intermediate sheave near the second link arm's outer end, and
a third, outer link arm arranged rotatable adjustable on the second, intermediate link arm and arranged with a third sheave near the third, outer link arm's outer end,
wherein the second, intermediate link arm's angle is controlled by use of a first actuator arranged between the first, inner link arm and the second link arm,
wherein the third, outer link arm's relative angle to the second, intermediate link arm is controlled by a second actuator arranged between the second, intermediate link arm and the third, outer link arm, and
wherein each sheave comprises a brake.

2. The tension control device according to claim 1, wherein the first, inner link arm is rotatable suspended about a shaft generally perpendicular to the shaft of at least the first, inner sheave and comprises an actuator, cross mounted, arranged for controlling the link arm's and accordingly the arm's angle about the shaft.

3. The tension control device according to claim 1, wherein the first, second, and the third sheave are provided with keyway slots respectively.

4. The tension control device according to claim 1, wherein the first, second, and the third sheave are arranged coplanar.

5. The tension control device according to claim 1, wherein the brakes comprise torque regulating motors.

6. The tension control device according claim 1, wherein the sheaves are arranged at the same side of the arm's link arms.

7. The tension control device according to claim 2, wherein the first, second, and the third sheave are provided with keyway slots respectively.

8. The tension control device according to claim 2, wherein the first, second, and the third sheave are arranged coplanar.

9. The tension control device according to claim 3, wherein the first, second, and the third sheave are arranged coplanar.

10. The tension control device according to claim 2, wherein the brakes comprise torque regulating motors.

11. The tension control device according to claim 3, wherein the brakes comprise torque regulating motors.

12. The tension control device according to claim 4, wherein the brakes comprise torque regulating motors.

13. The tension control device according to claim 2, wherein the sheaves are arranged at the same side of the aim's link arms.

14. The tension control device according to claim 3, wherein the sheaves are arranged at the same side of the arm's link arms.

15. The tension control device according to claim 4, wherein the sheaves are arranged at the same side of the arm's link arms.

16. The tension control device according to claim 5, wherein the sheaves are arranged at the same side of the arm's link arms.
